(19) United States
(12) Patent Application Publication
(10) Pub. No.: US 2007/0249313 A1
(43) Pub. Date: Oct. 25, 2007

(54) Multi-band antenna

(75) Inventors: Tadashi Oshiyama, Gunma (JP); Hirotoshi Mizuno, Gunma (JP); Yusuke Suzuki, Gunma (JP)

Correspondence Address: MORGAN LEWIS & BOCKIUS LLP, 1111 PENNSYLVANIA AVENUE NW, WASHINGTON, DC, 20004, US

(73) Assignee: Yokowo Co., Ltd.

(21) Appl. No.: 11/785,492

(22) Filed: Apr. 18, 2007

(30) Foreign Application Priority Data
Apr. 19, 2006 (JP) P. 2006-115489

(51) Int. Cl. H04B 1/18; H04B 1/06; H04M 1/00

(52) U.S. Cl. 455/272; 455/193.1; 455/575.7

(57) ABSTRACT

A multi-band antenna is adapted to operate in a first frequency band and a second frequency band which is higher than the first frequency band. A first antenna element is adapted to operate in the first frequency band, and has a first end which is electrically connected to the power feeding point and a second end which is electrically made open. A second antenna element is adapted to operate in the second frequency band, and has a third end which is electrically connected to the power feeding point and a fourth end which is electrically connected to the ground conductor. An electrical length of the first antenna element is set to ½ wavelength of the second frequency band, and an electrical length of the second antenna element is set to ¼ wavelength of the first frequency band.

### BACKGROUND

The present invention relates to a multi-band antenna employing a single antenna element adapted to operate in multiple frequency bands.

Recently, mobile communication has been rapidly advanced. Among them, cellular phones have widely spread to consumers, with development of reduction in size and weight. In the cellular phone, a PDC 800 MHz band and a PDC 1.5 GHz band are used in Japan, a GSM band and a DCS band are used in Europe, and an AMPS band and a PCS band are used in North America. Cellular phones incorporating a dual band system have become a mainstream in each region. Thus, in these cellular phones, antennas capable of transmitting and receiving the respective frequency bands are provided.

FIG. 18 shows a first example of a related-art multi-band antenna. In this example, a first antenna element 10 for a lower frequency band includes: one end “a” which is electrically connected to a power feeding point 12; a portion “ab” extending perpendicularly to a ground conductor 14; a portion “bc” which extends from the portion “ab” and which is bent in a meander shape; a portion “cd” which is connected to the portion “bc” so as to extend perpendicularly thereto; and the other end “d” which is grounded to the ground conductor 14. A length “abcd” of the first antenna element 10 is set to ½ wavelength of the lower frequency band. A second antenna element 16 for a higher frequency band includes the portion “ab” as a conductive path common to both antenna elements; a portion “be” which is continued from the portion “ab” so as to extend perpendicularly to the ground conductor 14; and a portion “ef” which is continued from the portion “be” so as to extend parallel to the ground conductor 14. An end “f” is not electrically connected to the ground conductor 14 and is electrically opened. An electrical length of the conductive path “abef” of the second antenna element 16 is set to ¼ wavelength of the higher frequency band. The first and second antenna elements 10, 16 are disposed so that the second antenna element 16 covers a part of the first antenna element 10.

FIG. 19 shows a second example of a related-art multi-band antenna. In this example, a configuration of a first antenna element 10 for a lower frequency band is the same as the first example shown in FIG. 18. A second antenna element 18 for a higher frequency band is formed by connecting intermediate portions “g” and “h” of the portions “ab” and “cd” of the first antenna element 10. The electrical length of the conductive path “aghd” is set to ½ wavelength of the higher frequency band.

In the above examples, since the electrical length “abcd” of the first antenna element 10 is set to ½ wavelength of the lower frequency band, and the length of the conductive path is relatively long, a wide installation space is necessary in spite of the meander shape. When a higher harmonic wave of the lower frequency band is included in a higher frequency band, the first antenna elements 10 and the second antenna elements 16, 18 interfere with each other and thus deterioration of an antenna gain considerably occurs at the higher frequency band. For example, at a frequency band used in Japan, second harmonic wave of PDC 800 MHz for the lower frequency band is partially overlaps with PDC 1.5 GHz for a higher frequency band, whereby deterioration in antenna characteristics occurs.

### SUMMARY

It is therefore one advantageous aspect of the invention to provide a downsized multi-band antenna in which two antenna elements do not interfere with each other.

According to one aspect of the invention, there is provided a multi-band antenna, adapted to operate in a first frequency band and a second frequency band which is higher than the first frequency band, the multi-band antenna comprising:

a power feeding point;

a ground conductor;

a first antenna element, adapted to operate in the first frequency band, and having a first end which is electrically connected to the power feeding point and a second end which is electrically made open; and

a second antenna element, adapted to operate in the second frequency band, and having a third end which is electrically connected to the power feeding point and a fourth end which is electrically connected to the ground conductor, wherein:

an electrical length of the first antenna element is set to ½ wavelength of the second frequency band, and an electrical length of the second antenna element is set to ¼ wavelength of the first frequency band.

With this configuration, impedance of the second antenna element is infinite at the first frequency band and impedance of the first antenna element is infinite at the second frequency band. Thus, the second antenna element does not interfere with a signal at the first frequency band communicated by the first antenna element, and the first antenna element does not interfere with a signal at the second frequency band communicated by the second antenna element. Accordingly, the first and second antenna elements do not interfere with each other, can independently operate as an antenna, and can provide a satisfactory gain at the first frequency band and the second frequency band.

A section having an electrical length of ⅛ wavelength or less of the second frequency band from the first end of the first antenna element and a section having an electrical length of ⅛ wavelength or less of the second frequency band from the third end of the second antenna element may share a common conductive path.

In this case, an installation space for the antenna is smaller than an installation space where separate conductive paths are provided.

The first antenna element may comprise a first section extending perpendicularly to the ground conductor so as to include the first end, and a second section continued from the first section and extending parallel to the ground conductor so as to include the second end. The second antenna element may comprise a third section extending perpendicularly to the ground conductor so as to include the third end, a fourth section continued from the third section and extending parallel to the ground conductor, and a fifth section continued from the fourth section and extending perpendicularly to the ground conductor so as to include the fourth end. Here, the first antenna element covers the third section and at least a part of the fourth section of the second antenna element.

In this case, the two antenna elements can be disposed in a small installation space.

The multi-band antenna may further comprise a matching circuit, electrically connecting the power feeding point and each of the first end of the first antenna element and the third end of the second antenna element, the matching circuit operable to match an impedance of the power feeding point and an impedance of each of the first antenna element and the second antenna element.

In this case, even when an electrical length of the first antenna element slightly deviates from a length where a signal at the first frequency band can resonate and an electrical length of the second antenna element slightly deviates from a length where a signal at the second frequency band can resonate, input/output impedance of the antennas can be properly adjusted.

The first frequency band may be one of PDC 800 MHz band, GSM band and AMPS band. The second frequency band may be one of PDC 1.5 GHz band, DCS band and PCS band.

The second frequency band may be a double of the first frequency band.

With this configuration, since, the first antenna element set to ½ wavelength of the second frequency band has about ¼ wavelength of the first frequency band and the second end is opened under a condition that the second frequency band is a double of the first frequency band, a signal at the first frequency band can resonate, thereby obtaining a high antenna gain. In addition, since the second antenna element set to ¼ wavelength of the first frequency band has about ½ wavelength of the second frequency band and the third end is grounded, a signal at the second frequency band can resonate, thereby obtaining a high antenna gain.

### BRIEF DESCRIPTION OF THE DRAWINGS

FIG. 1 is a schematic view showing a multi-band antenna according to a first embodiment of the invention.

FIG. 2 is a schematic view showing a modified example of the multi-band antenna of FIG. 1.

FIG. 3 is a circuit diagram of a matching circuit in the multi-band antenna of FIG. 2.

FIG. 4 is a VSWR characteristic graph obtained by the multi-band antenna of FIG. 2.

FIG. 5 is a table showing receiving efficiencies for respective frequency bands of multi-band antennas according to embodiments of the invention.

FIG. 6 is a schematic view showing a multi-band antenna according to a second embodiment of the invention.

FIG. 7 is a schematic view showing a modified example of the multi-band antenna of FIG. 6.

FIG. 8 is a circuit diagram of a matching circuit in the multi-band antenna of FIG. 7, in a case where an electrical length of a common conductive path is set to 1/32 wavelength of a higher frequency band.

FIG. 9 is a VSWR characteristic graph obtained by the multi-band antenna of FIG. 7 with the matching circuit of FIG. 8, in the case where the electrical length of the common conductive path is set to 1/32 wavelength of the higher frequency band.

FIG. 10 is a circuit diagram of a matching circuit in the multi-band antenna of FIG. 7, in a case where an electrical length of a common conductive path is set to 1/16 wavelength of a higher frequency band.

FIG. 11 is a VSWR characteristic graph obtained by the multi-band antenna of FIG. 7 with the matching circuit of FIG. 10, in the case where the electrical length of the common conductive path is set to 1/16 wavelength of the higher frequency band.

FIG. 12 is a circuit diagram of a matching circuit in the multi-band antenna of FIG. 7, in a case where an electrical length of a common conductive path is set to 3/32 wavelength of a higher frequency band.

FIG. 13 is a VSWR characteristic graph obtained by the multi-band antenna of FIG. 7 with the matching circuit of FIG. 12, in the case where the electrical length of the common conductive path is set to 3/32 wavelength of the higher frequency band.

FIG. 14 is a circuit diagram of a matching circuit in the multi-band antenna of FIG. 7, in a case where an electrical length of a common conductive path is set to ⅛ wavelength of a higher frequency band.

FIG. 15 is a VSWR characteristic graph obtained by the multi-band antenna of FIG. 7 with the matching circuit of FIG. 14, in the case where the electrical length of the common conductive path is set to ⅛ wavelength of the higher frequency band.

FIG. 16 is a circuit diagram of a matching circuit in the multi-band antenna of FIG. 7, in a case where an electrical length of a common conductive path is set to 5/32 wavelength of a higher frequency band.

FIG. 17 is a VSWR characteristic graph obtained by the multi-band antenna of FIG. 7 with the matching circuit of FIG. 16, in the case where the electrical length of the common conductive path is set to 5/32 wavelength of the higher frequency band.

FIG. 18 is a schematic view showing a first related-art multi-band antenna.

FIG. 19 is a schematic view showing a second related-art multi-band antenna.

### DETAILED DESCRIPTION OF THE EXEMPLARY EMBODIMENTS

Exemplary embodiments of the invention will be described below in detail with reference to the accompanying drawings. Components similar to those in the related-art examples will be designated by the same reference numerals, and repetitive explanations for those will be omitted.

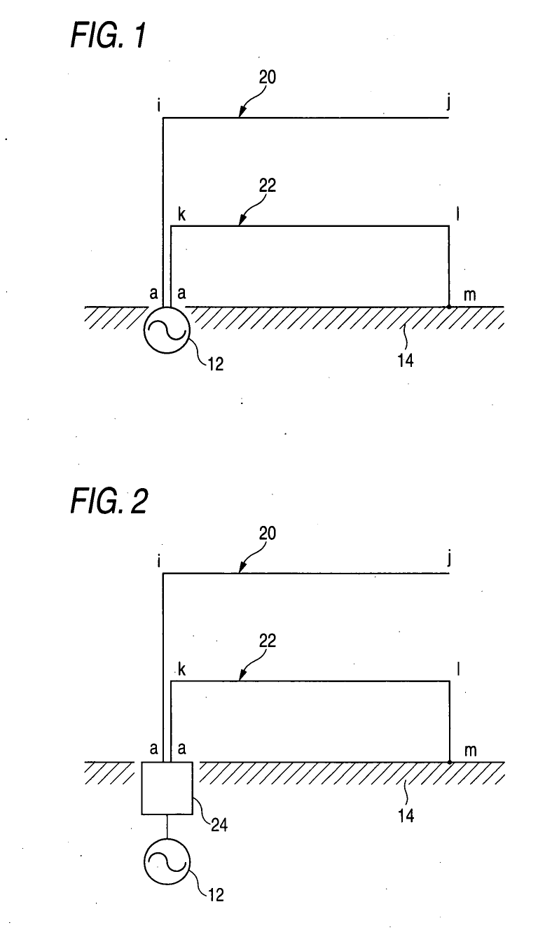

FIG. 1 shows a multi-band antenna according to a first embodiment of the invention. In this embodiment, a first antenna element 20 for a lower frequency band includes: one end “a” which is electrically connected to a power feeding point 12; a portion “ai” extending perpendicularly to a ground conductor 14 and a portion “ij” which is connected to the portion “ai” and which extends parallel to the ground conductor 14; and the other end “j” which is not electrically connected to the ground conductor 14 but is electrically opened. An electrical length of the conductive path “aij” of the first antenna element 20 is set to ½ wavelength of a higher frequency band.

On the other hand, a second antenna element 22 for the higher frequency band includes: one end “a” which is electrically connected to the power feeding point 12, a portion “ak” extending perpendicularly to the ground conductor 14; a portion “kl” which is connected to the portion “ak” and which extends parallel to the ground conductor 14; and a portion “lm” which is connected to the portion “kl” and extends perpendicularly to the ground conductor 14. The ends “a” and “m” are electrically connected to the ground conductor 14 to be grounded. An electrical length of the conductive path “aklm” of the second antenna element 22 is set to ¼ wavelength of the lower frequency band.

A length of the portion “ai” of the first antenna element 20 is set to be longer than a length of the portion “ak” of the second antenna element 22. The first antenna element 20 and the second antenna element 22 are disposed such that two portions “ak” and “kl” are covered with the first antenna element 20.

In this embodiment, impedance of the first antenna element 20 is infinite at the higher frequency band and impedance of the second antenna element 22 is infinite at the lower frequency band. Thus, when the antenna operates as the multi-band antenna for the lower frequency band and the higher frequency band, the first antenna element 20 and the second antenna element 22 do not interfere with each other and the antennas can independently operate. Accordingly, the gain deterioration due to the mutual interference like the related-art antenna does not occur.

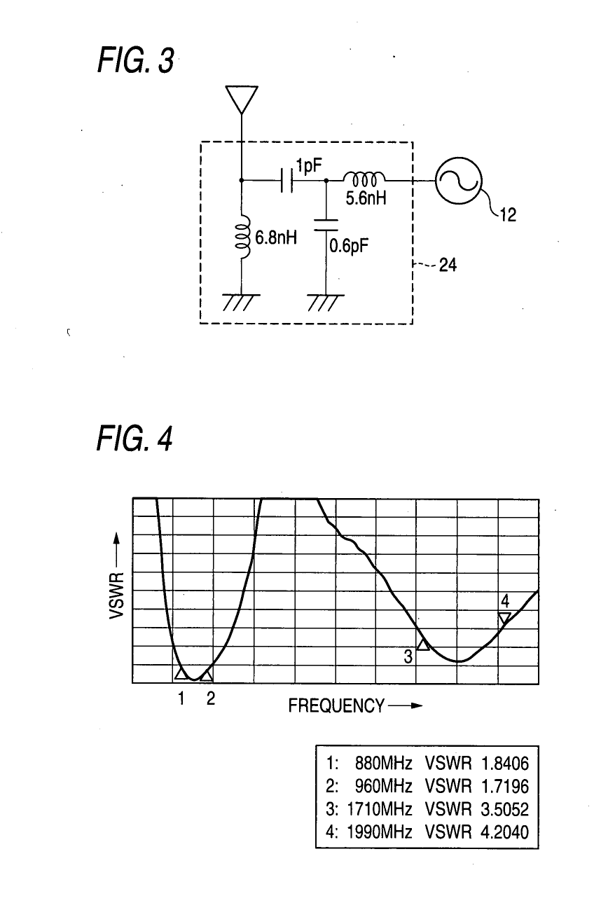

In a case where it is necessary to match input/output impedances of the first and second antenna elements 20, 22 and input/output impedance of the power feeding point 12 each other in the above configuration, a matching circuit 24 may be disposed between the ends “a” of the first and second antenna elements 20, 22 and the power feeding point 12 as shown in FIG. 2. An example of the matching circuit 24, as shown in FIG. 3, is formed of a proper LC circuit.

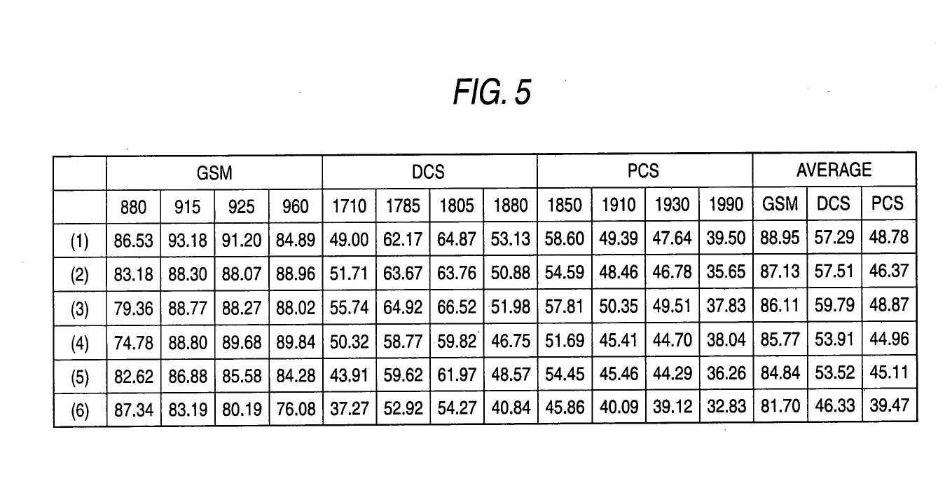

With this configuration, the electrical lengths of the first and second antenna elements 20, 22 were set so that the lower frequency band was a GSM band and the higher frequency band was a DCS band and a PCS band having twice the lower frequency band. Then, a VSWR characteristic thereof was measured. As the result, it was obtained a satisfactory characteristic that the VSWR is 2 or less in the frequency range of 880 to 960 MHz of the GSM band as shown in FIG. 4. The VSWR was about 4 or less in the frequency range of 1710 to 1990 MHz covering the DCS band and the PCS band. Therefore, it was obtained the result that the antenna can be sufficiently used as a multi-band antenna for the GSM and DCS band and/or the PCS band. In a receiving efficiency as shown in (1) of FIG. 5, as an average efficiency was 88.95% at the GSM band, 57.29% at the DCS band, and 48.78% at the PCS band, a sufficient antenna efficiency was obtained at any frequency band.

Next, a second embodiment of the invention will be described. Components similar to those in the first embodiment will be designated by the same reference numerals, and repetitive explanations for those will be omitted.

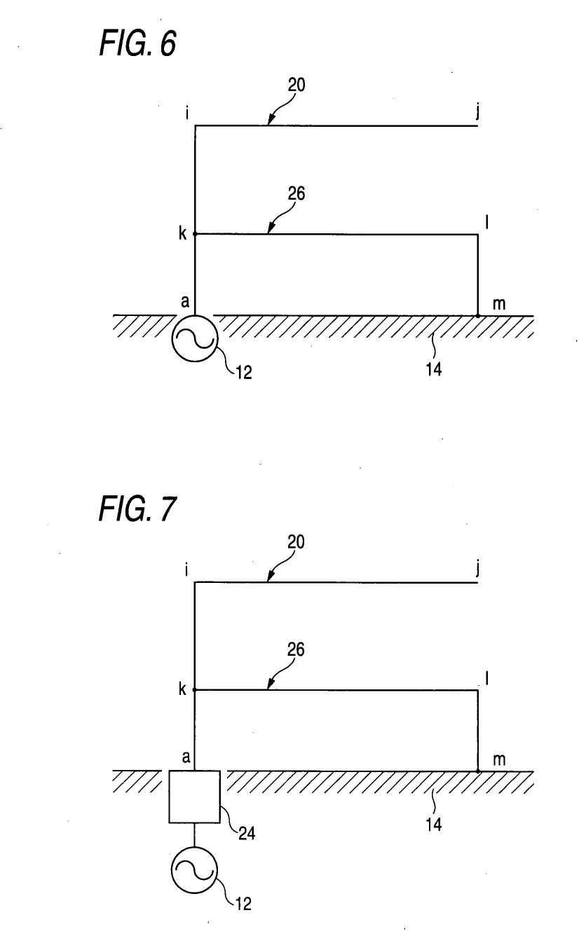

In this embodiment, as shown in FIG. 6, a portion “ak” of a second antenna element 26 for a higher frequency band is formed by using a conductive path in common with a part of a portion “ai” of a first antenna element 20 for the lower frequency band. The first antenna element 20 for the lower frequency band is the same as the first embodiment. The second antenna element 26 includes: the portion “ak” extending perpendicularly to the ground conductor 14; a portion “kl” which is connected to the portion “ak” and extends parallel to the ground conductor 14; and a potion “lm” which is connected to the portion “kl” and extends perpendicularly to the ground conductor 14.

In the common conductive path “ak”, impedance of the first antenna element 20 is infinite at a higher frequency and impedance of the second antenna element 26 is infinite at a lower frequency. Thus, the first and second antenna elements 20, 26 do not interfere with each other and can independently operate each other. Accordingly, the gain deterioration due to the mutual interference does not occur like the related-art antenna. Further, since the portion “ak” is shared by the first and second antenna elements 20, 26, the antenna can be easily downsized.

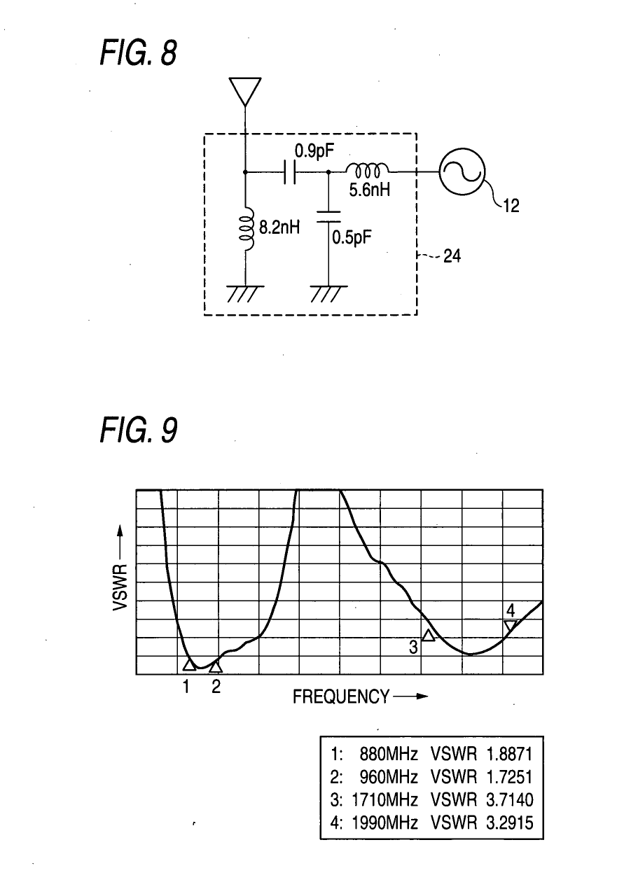

In a case where it is necessary to match input/output impedances of the first and second antenna elements 20, 26 and input/output impedance of the power feeding point 12 each other in the above configuration, a matching circuit 24 may be disposed between the end “a” of the first and second antenna elements 20, 26 and the power feeding point 12 as shown in FIG. 7. The matching circuit 24 is formed of a proper LC circuit shown in FIG. 8. Each value of elements forming the circuit is adjusted on the basis of the electrical length “ak” of the common conductive path.

With this antenna configuration, the electrical lengths of the first and second antenna elements 20, 26 were set so that the lower frequency band was a GSM band and a higher frequency band was a DCS band and PCS band having twice the lower frequency band, and further the electrical length “ak” of the common conductive path was varied and a constant of the match circuit 24 was properly set. Then, a VSWR characteristic thereof was measured.

As the result, when the electrical length “ak” of the common conductive path was set to 1/32 wavelength of the higher frequency band, it was obtained a satisfactory characteristic that the VSWR is 2 or less in the frequency range of 880 to 960 MHz of the GSM band as shown in FIG. 9. The VSWR was about 4 or less in the frequency range of 1710 to 1990 MHz covering the DCS band and the PCS band, and it was obtained the result that the antenna can be sufficiently used as a multi-band antenna for the GSM and DCS band and/or the PCS band. In a receiving efficiency as shown in (2) of FIG. 5, as an average efficiency was 87.13% at the GSM band, 57.51% at the DCS band, and 46.37% at the PCS band, a sufficient antenna efficiency was obtained at any frequency band.

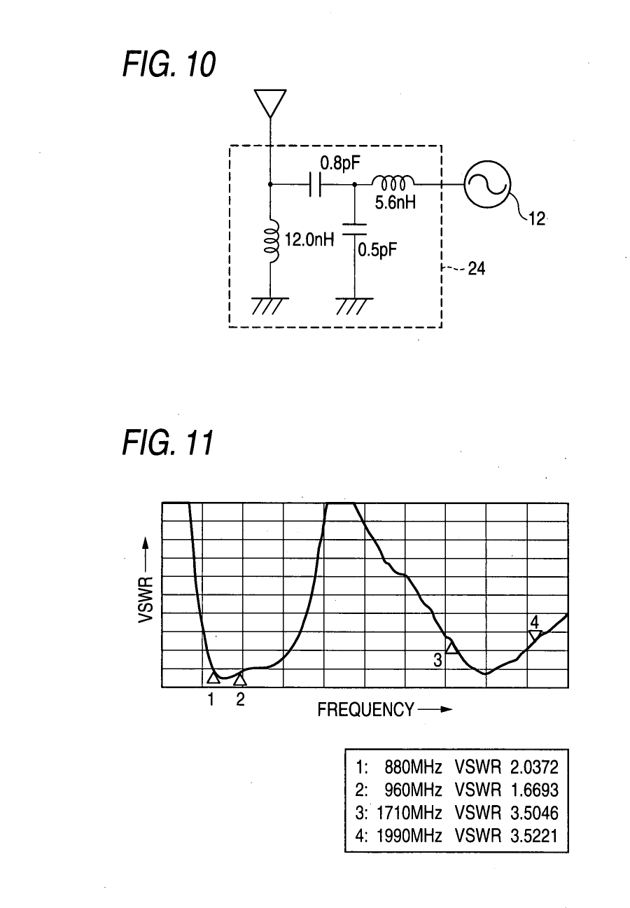

When the electrical length “ak” of the common conductive path was set to 1/16 wavelength of the higher frequency band (FIG. 10 shows one example of the matching circuit 24 in this case), it was obtained a satisfactory characteristic that the VSWR is about 2 or less in the frequency range of 880 to 960 MHz of the GSM band as shown in FIG. 11. The VSWR was about 4 or less in the frequency range of 1710 to 1990 MHz covering the DCS band and the PCS band, and it was obtained the result that the antenna can be sufficiently used as a multi-band antenna for the GSM and DCS band and/or the PCS band. In a receiving efficiency as shown in (3) of FIG. 5, as an average efficiency was 86.11% at the GSM band, 59.79% at the DCS band, and 48.87% at the PCS band, a sufficient antenna efficiency was obtained at any frequency band.

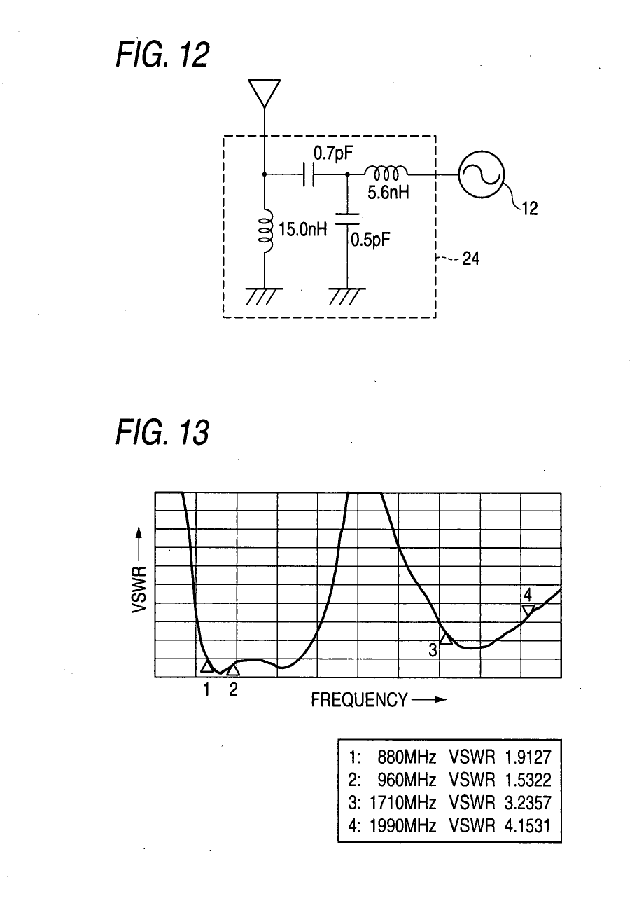

When the electrical length “ak” of the common conductive path was set to 3/32 wavelength of the higher frequency band (FIG. 12 shows one example of the matching circuit 24 in this case), it was obtained a satisfactory characteristic that the VSWR is 2 or less in the frequency range of 880 to 960 MHz of the GSM band as shown in FIG. 13. The VSWR was about 4 or less in the frequency range of 1710 to 1990 MHz covering the DCS band and the PCS band, and it was obtained the result that the antenna can be sufficiently used as a multi-band antenna for the GSM and DCS band and/or the PCS band. In a receiving efficiency as shown in (4) of FIG. 5, as an average efficiency was 85.77% at the GSM band, 53.91% at the DCS band, and 44.96% at the PCS band, a sufficient antenna efficiency was obtained at any frequency band.

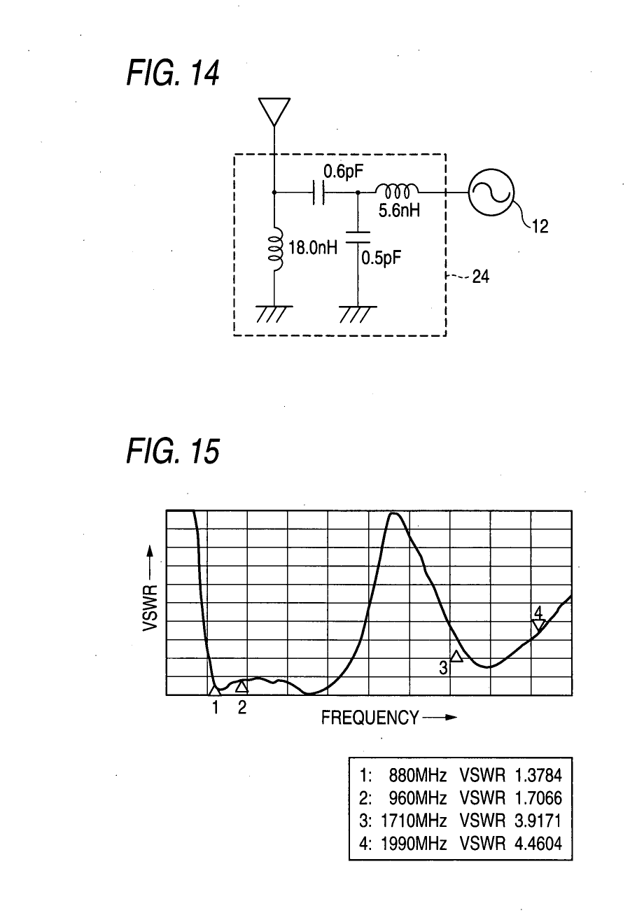

When the electrical length “aa” of the common conductive path was set to ⅛ wavelength of the higher frequency band (FIG. 14 shows one example of the matching circuit 24 in this case), it was obtained a satisfactory characteristic that the VSWR is 2 or less in the frequency range of 880 to 960 MHz of the GSM band as shown in FIG. 15. The VSWR was about 4 or less in the frequency range of 1710 to 1990 MHz influenced on the DCS band and the PCS band and it was obtained the result that the antenna can be sufficiently used as a multi-band antenna for the GSM and DCS band and/or the PCS band. In a receiving efficiency as shown in (5) of FIG. 5, as an average efficiency was 84.84% at the GSM band, 53.52% at the DCS band, and 45.11% at the PCS band, a sufficient antenna efficiency was obtained at any frequency band.

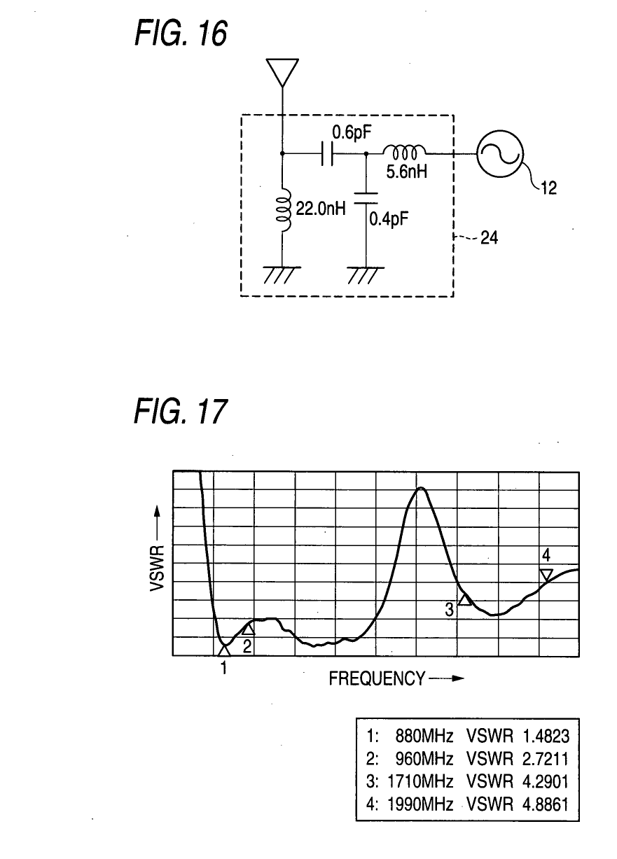

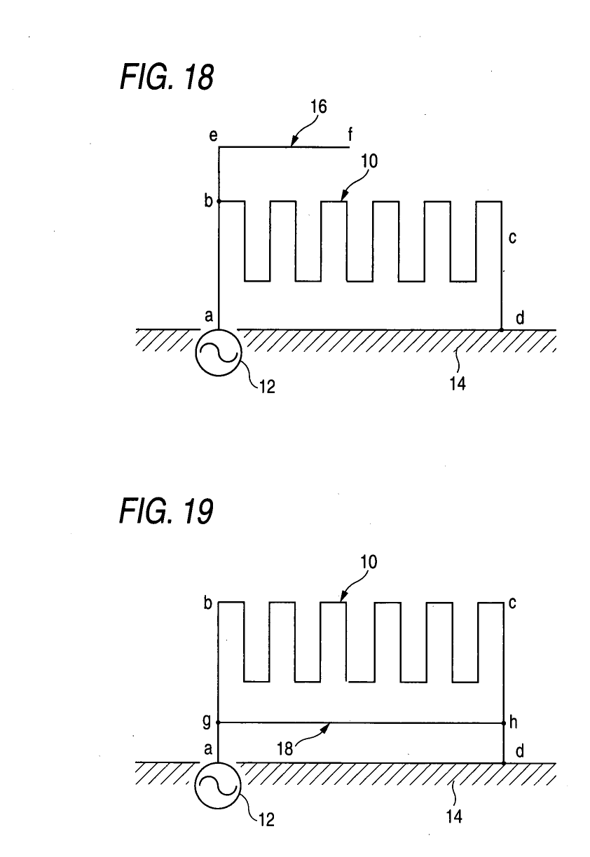

However, when the electrical length “ak” of the common conductive path is set to 5/32 wavelength of the higher frequency band (FIG. 16 shows one example of the matching circuit 24 in this case), the VSWR was much larger than 2 in the frequency range of 880 to 960 MHz of the GSM band as shown in FIG. 17. The VSWR was much larger than 4 in the frequency range of 1710 to 1990 MHz covering the DOCS band and the PCS band, and the antenna cannot be sufficiently used as a multi-band antenna for the GSM and DOCS band and/or the PCS band. In a receiving efficiency as shown in (6) of FIG. 5, as an average efficiency was 81.70% at the GSM band and 46.33% at the DCS band and thus there is no problem in the receiving efficiency in these frequency range. However, since the average efficiency was 39.47% at the PCS band, the receiving efficiency was not sufficient. Accordingly, the proper electrical length “ak” of the common conductive path is ⅛ or less wavelength of a higher frequency band.

In the second embodiment, the portion “ak” of the second antenna element 26 is formed by using the conductive path common to the perpendicular portion “ai” of the first antenna element 20. However, only a part of the portion “ak” of the second antenna element 26 may be formed by using the common conductive path.

In the above embodiments, the GSM band is set as the lower frequency band and the DCS and PCS bands are set as the higher frequency band in the frequency range. However, any one of the PDC 800 MHz band, the GSM band, and the AMPS band may be set as the lower frequency band, and any one of the PDC 1.5 GHZ band, the DCS band, and the PCS band may be set as a higher frequency band. In addition, each of the lower frequency band and the higher frequency band may be contained in a plurality of frequency bands. Further, the lower frequency band and higher frequency band are not limited to frequency bands for cellar phones. Rather, a frequency band for another mobile communication may be selected.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2006-115489 filed Apr. 19, 2007 including specification, drawings and claims is incorporated herein by reference in its entirety.

What is claimed is:

1. A multi-band antenna, adapted to operate in a first frequency band and a second frequency band which is higher than the first frequency band, the multi-band antenna comprising:
a power feeding point;
a ground conductor;
a first antenna element, adapted to operate in the first frequency band, and having a first end which is electrically connected to the power feeding point and a second end which is electrically made open; and
a second antenna element, adapted to operate in the second frequency band, and having a third end which is electrically connected to the power feeding point and a fourth end which is electrically connected to the ground conductor, wherein:
an electrical length of the first antenna element is set to ½ wavelength of the second frequency band, and an electrical length of the second antenna element is set to ¼ wavelength of the first frequency band.

2. The multi-band antenna as set forth in claim 1, wherein the second frequency band is a double of the first frequency band.

3. The multi-band antenna as set forth in claim 1, wherein a section having an electrical length of ⅛ wavelength or less of the second frequency band from the first end of the first antenna element and a section having an electrical length of ⅛ wavelength or less of the second frequency band from the third end of the second antenna element share a common conductive path.

4. The multi-band antenna as set forth in claim 1, wherein:
the first antenna element comprises a first section extending perpendicularly to the ground conductor so as to include the first end, and a second section continued from the first section and extending parallel to the ground conductor so as to include the second end:
the second antenna element comprises a third section extending perpendicularly to the ground conductor so as to include the third end, a fourth section continued from the third section and extending parallel to the ground conductor, and a fifth section continued from the fourth section and extending perpendicularly to the ground conductor so as to include the fourth end; and
the first antenna element covers the third section and at least a part of the fourth section of the second antenna element.

5. The multi-band antenna as set forth in claim 1, further comprising:
a matching circuit, electrically connecting the power feeding point and each of the first end of the first antenna element and the third end of the second antenna element, the matching circuit operable to match an impedance of the power feeding point and an impedance of each of the first antenna element and the second antenna element.

6. The multi-band antenna as set forth in claim 1, wherein:
the first frequency band is one of PDC 800 MHz band, GSM band and AMPS band; and
the second frequency band is one of PDC 1.5 GHz band, DCS band and PCS band.
